(19) United States
(12) Patent Application Publication
(10) Pub. No.: US 2024/0240963 A1
(43) Pub. Date: Jul. 18, 2024

(54) PARKING ASSISTANCE DEVICE AND PARKING ASSISTANCE METHOD

(71) Applicants: DENSO CORPORATION, Kariya-city (JP); TOYOTA JIDOSHA KABUSHIKI KAISHA, Toyota-shi (JP)

(72) Inventors: SHINJI KITAURA, Tokyo (JP); YU HIEI, Nagoya-shi (JP); YUKI MINASE, Toyota-shi (JP); MOTONARI OBAYASHI, Nagakute-shi (JP)

(21) Appl. No.: 18/618,933

(22) Filed: Mar. 27, 2024

Related U.S. Application Data
(63) Continuation of application No. PCT/JP2022/034639, filed on Sep. 15, 2022.

(30) Foreign Application Priority Data
Sep. 29, 2021 (JP) 2021-159852

(51) Int. Cl. G01C 21/36; B60W 30/06; G08G 1/14

(52) U.S. Cl. CPC G01C 21/3685; B60W 30/06; G08G 1/14; B60W 2552/05

(57) ABSTRACT

A parking assistance device is configured to search for a parking space for parking a vehicle in a parking lot based on surrounding information of the vehicle, provide a user with information for prompting a selection of a target parking space for parking the vehicle from the parking space, and set a target parking position of the vehicle based on the target parking space. The parking assistance device provides the user with area information having a range including a plurality of parking spots in the parking space as a designated range.

### CROSS REFERENCE TO RELATED APPLICATION

The present application is a continuation application of International Patent Application No. PCT/JP2022/034639 filed on Sep. 15, 2022 which designated the U.S. and claims the benefit of priority from Japanese Patent Application No. 2021-159852 filed on Sep. 29, 2021. The entire disclosures of all of the above applications are incorporated herein by reference.

### TECHNICAL FIELD

The present disclosure relates to a parking assistance device and a parking assistance method for assisting traveling and parking of a vehicle in a parking lot.

### BACKGROUND

In a related art, a technique is well-known in which when a user performs parking at a position other than a desired parking position in a parking lot, an vacant state of the desired parking position is monitored in a parking lot management facility, and a vehicle is caused to automatically move to the desired parking position when the desired parking position is vacant.

### SUMMARY

A parking assistance device is configured to search for a parking space for parking a vehicle in a parking lot based on surrounding information of the vehicle, provide a user with information for prompting a selection of a target parking space for parking the vehicle from the parking space, and set a target parking position of the vehicle based on the target parking space. The parking assistance device provides the user with area information having a range including a plurality of parking spots in the parking space as a designated range.

### BRIEF DESCRIPTION OF DRAWINGS

FIG. 1 is a schematic configuration diagram of an automatic parking system according to an embodiment.

FIG. 2 is a diagram illustrating an example of a display content on a display unit.

FIG. 3 is a diagram illustrating a part of the display content on the display unit during search traveling.

FIG. 4 is a diagram illustrating a modification of the display content on the display unit during the search traveling.

FIG. 5 is a diagram illustrating an example of a parking lot.

FIG. 6 is a flowchart showing an example of a control process executed by a vehicle control unit of a parking assistance device.

FIG. 7 is a flowchart showing an example of a search traveling process executed by the vehicle control unit.

FIG. 8 is a diagram illustrating a parking orientation of a vehicle.

FIG. 9 is a flowchart showing an example of a designation change process executed by the vehicle control unit during the search traveling.

FIG. 10 is a flowchart showing an example of a parking assistance process executed by the vehicle control unit.

FIG. 11 is a diagram illustrating a first modification of a display form of a designated range indicated as area information for the display unit.

FIG. 12 is a diagram illustrating a second modification of the display form of the designated range indicated as the area information for the display unit.

FIG. 13 is a diagram illustrating a third modification of the display form of the designated range indicated as the area information for the display unit.

FIG. 14 is a diagram illustrating a fourth modification of the display form of the designated range indicated as the area information for the display unit.

FIG. 15 is a diagram illustrating a fifth modification of the display form of the designated range indicated as the area information for the display unit.

FIG. 16 is a diagram illustrating a sixth modification of the display form of the designated range indicated as the area information for the display unit.

FIG. 17 is a diagram illustrating a seventh modification of the display form of the designated range indicated as the area information for the display unit.

FIG. 18 is a diagram illustrating another example of a parking lot.

### DETAILED DESCRIPTION

The technique described in a related art is based on the premise that a target parking position in a parking lot can be specified in advance, and does not assume a situation, for example, in which the vehicle travels in the parking lot while searching for the target parking position.

The present inventors have diligently studied a case of assisting in traveling and parking of a vehicle in a parking lot. As a result, for example, when searching for a parking space while traveling in a parking lot, it has been found that it is difficult to specify a parking spot suitable for parking a vehicle from the parking space at a pinpoint, and that it is difficult to set the target parking position of the vehicle. A reason may be that, when searching for a parking space while traveling in a parking lot, from the viewpoint of convenience, it is necessary to cause the vehicle to travel at a speed higher than that during parking, or there are many obstacles (for example, other vehicles) that hinder specifying the parking space in the parking lot.

The present disclosure provides a parking assistance device and a parking assistance method capable of setting a target parking position of a vehicle even in a situation in which it is difficult to specify a parking spot suitable for parking the vehicle.

According to one aspect of the present disclosure, a parking assistance device that assists traveling and parking of a vehicle in a parking lot is provided. The parking assistance device comprises: a space recognition unit configured to search for a parking space for parking the vehicle in the parking lot based on surrounding information of the vehicle acquired by a surrounding monitoring sensor mounted on the vehicle; an information provision unit configured to provide a user with information for prompting a selection of a target parking space for parking the vehicle from the parking space obtained as a search result in the parking lot; and a target position setting unit configured to set a target parking position of the vehicle based on the target parking space selected by the user. The information provision unit provides the user with area information having a range including a plurality of parking spots in the parking space as a designated range.

According to one aspect of the present disclosure, a parking assistance method that assists traveling and parking of a vehicle in a parking lot is provided The parking assistance method comprises: searching for a parking space for parking the vehicle in the parking lot based on surrounding information of the vehicle acquired by a surrounding monitoring sensor mounted on the vehicle; providing a user with information for prompting a selection of a target parking space for parking the vehicle from the parking space obtained as a search result in the parking lot; and setting a target parking position of the vehicle based on the target parking space selected by the user. When a selection of the target parking space in which the vehicle is to be parked from the parking space is promoted, the user is provided with area information having a range including a plurality of parking spots in the parking space as a designated range.

As described above, it is desirable to provide the user with the area information having the range including the multiple parking spots in the parking space as the designated range, and set the target parking position from the target parking space selected by the user based on the provided information. In this manner, even in a situation in which it is difficult to specify a single parking spot suitable for parking the vehicle by a space recognition unit, the target parking position of the vehicle can be set by providing the area information to the user and effectively utilizing recognition capability of the user through selection of the target parking space or the like.

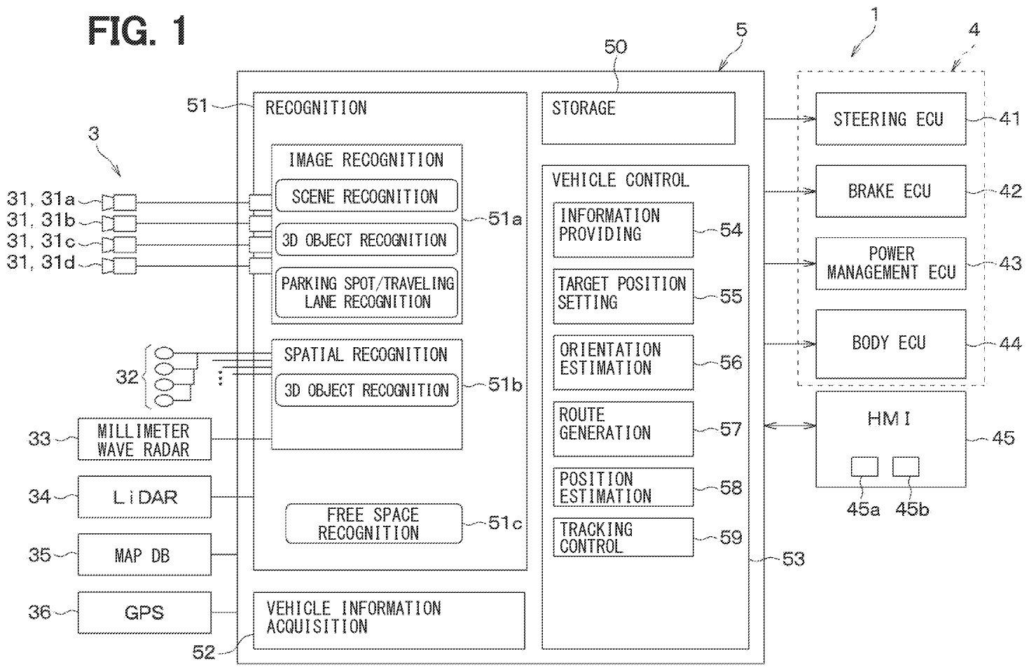

An embodiment of the present disclosure will be described with reference to FIGS. 1 to 10. In the present embodiment, an example in which a parking assistance device 5 and a parking assistance method according to the present disclosure are applied to an automatic parking system 1 will be described. As shown in FIG. 1, the automatic parking system 1 includes a surrounding monitoring sensor 3, various ECUs 4, and the parking assistance device 5. The parking assistance device 5 is communicably connected to the surrounding monitoring sensor 3 and the various ECUs 4 directly or via an in-vehicle local area network (LAN) or the like.

The surrounding monitoring sensor 3 is an autonomous sensor that is mounted on a subject vehicle V (hereinafter also referred to as a subject vehicle Vo) and monitors a surrounding environment of the subject vehicle Vo. For example, the surrounding monitoring sensor 3 detects a moving dynamic target such as a pedestrian or other vehicles, an obstacle including a stationary three-dimensional object around the subject vehicle Vo such as a structure on a road, a parking spot indicating parking information which is information on a parking lot PL, a traveling lane, or the like as a detection target object. The subject vehicle Vo includes, as the surrounding monitoring sensor 3, surrounding monitoring cameras 31 that each capture an image of a predetermined range around the subject vehicle Vo and a probe wave sensor.

The surrounding monitoring camera 31 corresponds to an imaging device, captures a surrounding image of the subject vehicle, and outputs imaging data as sensing information to the parking assistance device 5. Here, as the surrounding monitoring camera 31, a front camera 31a, a rear camera 31b, a left lateral camera 31c, and a right lateral camera 31d that capture images of the front, rear, and right and left of the vehicle are exemplified, but the present disclosure is not limited thereto.

The probe wave sensor outputs probe waves and sequentially outputs measurement results such as a relative speed and a relative distance to a target and an azimuth angle at which the target exists obtained by acquiring the reflected waves to the parking assistance device 5 as the sensing information. The probe wave sensor includes a sonar 32, a millimeter wave radar 33, and a light detection and ranging (LiDAR) 34 that transmit probe waves to a predetermined range around the subject vehicle Vo.

The sonar 32 performs measurement using ultrasonic waves as the probe waves, and is provided at multiple locations with respect to the vehicle V, for example, multiple sonars 32 are disposed side by side in a vehicle left-right direction on front and rear bumpers, and perform measurement by outputting a probe wave to the surrounding of the vehicle. The millimeter wave radar 33 performs measurement using millimeter waves as the probe waves. The LiDAR 34 performs measurement using laser light as the probe wave. Both the millimeter wave radar 33 and the LiDAR 34 output, for example, the probe wave within a predetermined range in front of the vehicle V, and perform measurement within the output range.

In the present embodiment, as an example, the surrounding monitoring sensor 3 includes the surrounding monitoring cameras 31, the sonars 32, the millimeter wave radar 33, and the LiDAR 34, but one or multiple combinations of these sensors may be used to monitor the surrounding, and none of the sensors may be provided.

The parking assistance device 5 is connected to a map database 35 and a GPS 36, and can measure a current position of the subject vehicle Vo. The map database 35 may be constructed in an in-vehicle device, or may be constructed in a device outside the vehicle (for example, an external server).

The parking assistance device 5 constitutes an ECU (that is, an electronic control device) for performing various types of control for implementing the parking assistance method in the automatic parking system 1, and is implemented by a microcomputer including a CPU, a storage unit 50, an I/O, and the like.

The storage unit 50 includes a ROM, a RAM, an EEPROM, and the like. That is, the storage unit 50 includes a volatile memory such as the RAM and a non-volatile memory such as the EEPROM. The storage unit 50 is implemented by a non-transitory tangible recording medium.

The parking assistance device 5 is a device that assists traveling and parking of the subject vehicle Vo in the parking lot PL. The parking assistance device 5 searches the parking lot PL for a parking space SP for parking the subject vehicle Vo in the parking lot PL based on surrounding information of the subject vehicle Vo obtained when the subject vehicle Vo travels in the parking lot PL. The parking assistance device 5 generates a target route through which the subject vehicle Vo should pass. The target route includes a search route DP through which the vehicle V should pass during the search traveling in which the vehicle V travels in the parking lot PL while searching the parking lot PL for the parking space SP, and a parking route TP through which the vehicle V should pass during the parking of the subject vehicle Vo. The “ surrounding information” is, for example, information on a dynamic target such as a person or other vehicles around the subject vehicle Vo, a curbstone around the subject vehicle Vo, a static target such as a building, various signs, a parking spot, and a road surface marking such as a traveling lane. For example, the parking assistance device 5 causes the subject vehicle Vo to automatically move along the search route DP during the search traveling. The parking assistance device 5 causes the subject vehicle Vo to automatically move to a target parking position SEP along the parking route TP during the parking assistance. The target parking position SEP is an end point of the parking route TP.

Specifically, when an instruction to perform the parking assistance is issued, for example, when a parking assistance switch (not shown) is operated by a user, the parking assistance device 5 starts the search traveling. The parking assistance device 5 recognizes a target on the search route DP of the vehicle V, the parking space SP for parking the subject vehicle Vo, and the like based on the sensing information of the surrounding monitoring sensor 3 during the search traveling. The recognition result thereof is sequentially stored in the non-volatile memory of the storage unit 50 and used for the parking assistance or the like.

Subsequently, the parking assistance device 5 transmits, to the user, information for prompting a selection of a target parking space TS during the search traveling. After setting the target parking position SEP based on the target parking space TS selected by the user, the parking assistance device 5 starts the parking assistance of the subject vehicle Vo at the target parking position SEP. That is, the parking assistance device 5 generates the parking route TP to the target parking position SEP based on the sensing information of the surrounding monitoring sensor 3 during the search traveling and the parking assistance, and performs route tracking control according to the route. Specifically, the parking assistance device 5 includes a recognition processing unit 51, a vehicle information acquisition unit 52, and a vehicle control unit 53 as functional units that execute various types of control.

The recognition processing unit 51 receives the sensing information from the surrounding monitoring sensor 3, and performs recognition of the surrounding environment of the subject vehicle Vo to be parked, scene recognition of a type of a parking scene, and recognition of an object existing around the subject vehicle Vo based on the sensing information. Here, the recognition processing unit 51 includes an image recognition unit 51a, a spatial recognition unit 51b, and a free space recognition unit 51c.

The image recognition unit 51a performs the scene recognition, three-dimensional object recognition, parking spot/traveling lane recognition, and the like. Various types of recognition performed by the image recognition unit 51a are implemented by performing an image analysis on imaging data from the surrounding monitoring camera 31 received as the sensing information.

In the scene recognition, it is recognized what type of scene the parking scene is. For example, it is recognized whether the subject vehicle is in a normal parking scene in which there is no obstacle in the parking lot PL and the parking of the subject vehicle Vo at the target parking position SEP is not particularly limited or a special parking scene in which the parking of the subject vehicle Vo at the target parking position SEP is limited by an obstacle.

Since the imaging data received from the surrounding monitoring camera 31 shows a state of the surrounding thereof, it is possible to determine whether the subject vehicle is in the normal parking scene or the special parking scene by analyzing the image thereof. For example, when an object around the subject vehicle Vo is detected from the imaging data and the object becomes an obstacle to the traveling or parking of the subject vehicle Vo, it can be determined that the subject vehicle Vo is in the special parking scene. The scene recognition may be performed based on not only the sensing information of the surrounding monitoring camera 31 but also the sensing information of the probe wave sensor.

In the three-dimensional object recognition, an obstacle constituted by a three-dimensional object existing around the subject vehicle, such as a dynamic target or a static target, is recognized as a detection target object. The scene recognition and generation of a parking assistance map including the obstacle are performed based on a shape of the detection target object recognized by the three-dimensional object recognition, preferably, the static object among the detection target objects.

The spatial recognition unit 51b performs the three-dimensional object recognition, and the like. The spatial recognition unit 51b performs the three-dimensional object recognition in a space around the subject vehicle Vo based on the sensing information from at least one of the sonar 32, the millimeter wave radar 33, and the LiDAR 34. The three-dimensional object recognition here is the same as the three-dimensional object recognition performed by the image recognition unit 51a. Therefore, if either the image recognition unit 51a or the spatial recognition unit 51b is provided, the three-dimensional object recognition can be performed. In the present embodiment, the spatial recognition unit 51b does not perform the scene recognition, but the spatial recognition unit 51b can perform the scene recognition based on the sensing information from at least one of the sonar 32, the millimeter wave radar 33, and the LiDAR 34.

Although the three-dimensional object recognition and the scene recognition can be performed by either the image recognition unit 51a or the spatial recognition unit 51b, more accurate three-dimensional object recognition and scene recognition can be performed by using both the image recognition unit 51a and the spatial recognition unit 51b. For example, by the three-dimensional object recognition and the scene recognition performed by the spatial recognition unit 51b complementing the three-dimensional object recognition and the scene recognition performed by the image recognition unit 51a, the three-dimensional object recognition and the scene recognition can be performed more accurately.

The free space recognition unit 51c performs free space recognition for recognizing a place which is a free space from the parking lot PL. The free space means, for example, the parking space SP in the parking lot PL in which the vehicle V can be parked. The parking space SP includes one or multiple parking spots set in the parking lot PL. The parking spot is a space having a size and a shape allowing one vehicle V to be parked in the parking space SP, and a region of the parking spot is subjected to a road surface display with, for example, a white line as a parking marking in the parking lot PL. The parking spot may be not only the region subjected to the road surface display with the white line, but also a region in which the vehicle V can be parked, such as a space between other vehicles V or a space in which a wheel stopper is provided.

The free space recognition unit 51c recognizes the free space in the parking lot PL based on the recognition results of the scene recognition and the three-dimensional object recognition performed by the image recognition unit 51a and the spatial recognition unit 51b. For example, since the shape of the parking lot PL and the presence or absence of parking of other vehicle can be grasped from the results of the scene recognition and the three-dimensional object recognition, a free space is recognized from the parking lot PL based on the shape of the parking lot PL and the presence or absence of parking of other vehicle. In addition, the free space recognition unit 51c specifies a free space from the image by using, for example, semantic segmentation in which pixels in the image are classified into categories based on surrounding information of the pixels. In this description, the free space recognition unit 51c constitutes a “space recognition unit” that searches the parking lot PL for the parking space SP for parking the subject vehicle Vo based on the surrounding information of the subject vehicle Vo acquired by the surrounding monitoring sensor 3 mounted on the subject vehicle Vo.

The vehicle information acquisition unit 52 acquires information on an operation amount of the vehicle V from another ECU 4 or the like. Specifically, the vehicle information acquisition unit 52 acquires detection signals output from sensors such as an accelerator position sensor, a brake pedal force sensor, a steering angle sensor, a wheel speed sensor, and a shift position sensor that are mounted on the vehicle V.

The vehicle information acquisition unit 52 obtains a traveling speed of the subject vehicle Vo based on a sensor output of the wheel speed sensor. The traveling speed may be obtained based on an output of a device other than the wheel speed sensor.

The vehicle control unit 53 executes various types of control required for the search traveling and the parking assistance. Specifically, the vehicle control unit 53 includes an information provision unit 54, a target position setting unit 55, an orientation estimation unit 56, a route generation unit 57, a position estimation unit 58, and a tracking control unit 59 as functional units that execute various types of control.

The information provision unit 54 provides the user with information for prompting the selection of the target parking space TS in which the subject vehicle Vo is parked from the parking spaces SP obtained from a search result of the free space recognition unit 51c. The target parking space TS is a part of the parking space SP and is a space as a candidate for the target parking position SEP. The target parking space TS includes, for example, two or more parking spots. The information provision unit 54 provides, to the user, area information having a range including multiple parking spots in the parking space SP as a designated range.

Specifically, the information provision unit 54 provides the area information to the user using a human machine interface (HMI) 45. The HMI 45 is a device for performing various types of assistance for the user. The HMI 45 includes a display unit 45a and a voice input and output unit 45b.

The display unit 45a is one device that provides information to the user in a visual manner. The display unit 45a is a touch panel display used in a navigation system or a meter system. The display unit 45a may be a display that does not receive a touch operation, a head-up display, or the like.

The voice input and output unit 45b is one device that provides information to the user in an auditory manner. The voice input and output unit 45b includes a microphone as a voice input unit and a speaker as a voice output unit.

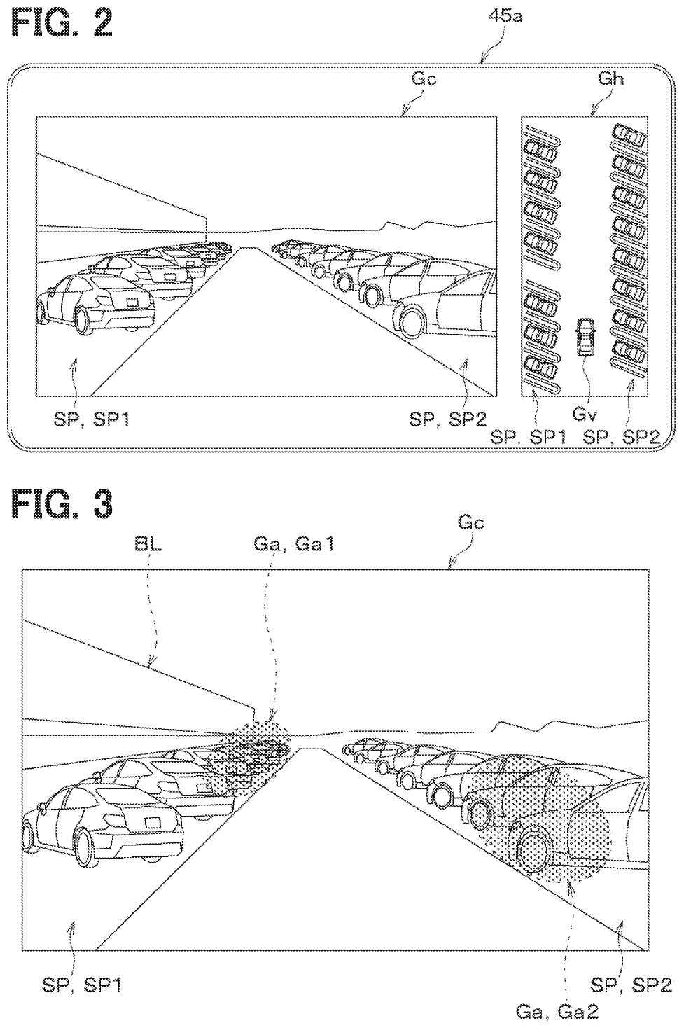

The information provision unit 54 provides various types of information to the user through the display unit 45a of the HMI 45 in the visual manner. For example, as shown in FIG. 2, the information provision unit 54 displays a camera viewpoint image Gc showing a front in a traveling direction of the subject vehicle Vo in a left region of the display unit 45a and displays an overhead view image Gh in a right region of the display unit 45a during the search traveling. The display positions, sizes, and the like of the camera viewpoint image Gc and the overhead view image Gh are merely examples, and may be different from those in FIG. 2.

Here, In FIG. 2 and other figures, the camera viewpoint image Gc is an image in which an arrangement position of a lens of a camera (in this example, the front camera 31a) that captures an image of scenery in a scheduled traveling direction of the subject vehicle Vo is set as a viewpoint. In addition, the overhead view image Gh is an image in which a virtual vehicle image Gv is superimposed on a virtual viewpoint image obtained by cutting out, as an image, a region on a projected curved surface included in a predetermined viewing angle when the projected curved surface is viewed from a virtual viewpoint set directly above the subject vehicle Vo. The camera viewpoint image Gc and the overhead view image Gh are generated based on images captured by the surrounding monitoring camera 31 during the search traveling and the parking assistance.

During the search traveling, for example, as shown in FIG. 3, the information provision unit 54 displays, on the display unit 45a, a superimposed image in which the area information having the range including the multiple parking spots as the designated range is superimposed on the camera viewpoint image Gc.

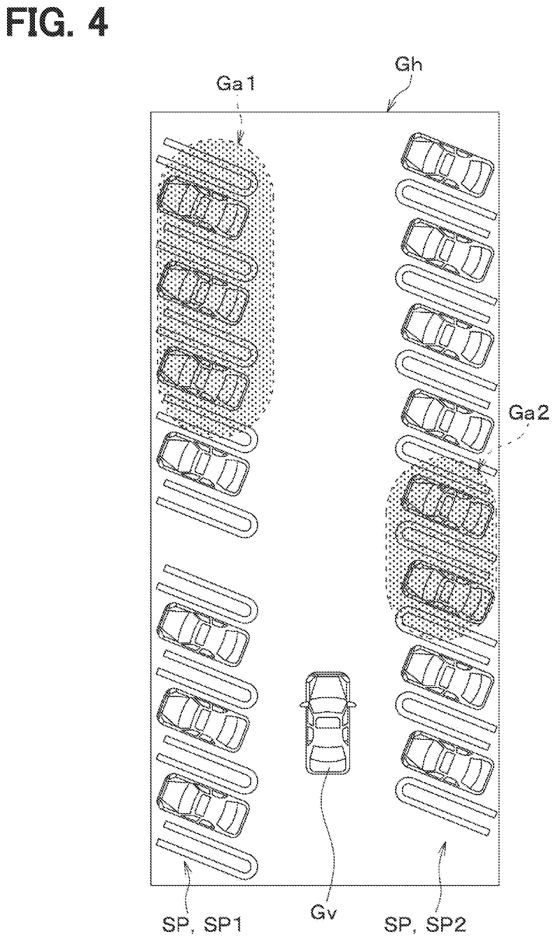

In the example shown in FIG. 3, elliptical round frame images Ga respectively surrounding multiple parking spots reflected in a front left portion of the subject vehicle Vo and multiple parking spots reflected in a front right portion of the subject vehicle Vo are superimposed on the camera viewpoint image Gc, and the superimposed image is provided to the user as the area information. Portions of the image shown in FIG. 3 on which the round frame image Ga is superimposed each indicate a range (that is, a designated range) in which the user can select the target parking space TS. For example, as shown in FIG. 4, the information provision unit 54 may display, on the display unit 45a, a superimposed image in which the round frame images Ga1 and Ga2 each having an elongated oval shape are superimposed on the overhead view image Gh.

In addition to the image display, the information provision unit 54 provides, to the user, a message for prompting the selection of the target parking space TS. This information provision is implemented, for example, by displaying a message for prompting the selection of the target parking space TS on the display unit 45a or by a voice output of the message from the voice input and output unit 45b. For example, the information provision unit 54 provides, to the user, a message for prompting a touch operation or an utterance for designating a position of the target parking space TS.

After providing the user with the information for prompting the selection of the target parking space TS, the information provision unit 54 acquires a selection result of the target parking space TS by the user based on an operation signal of the touch operation on the display unit 45a and a recognition result of information uttered by the user. The information provision unit 54 may acquire the selection result of the target parking space TS by the user based on an operation signal of a selection button displayed on the display unit 45a or an operation signal of a selection switch provided separately from the display unit 45a. The HMI 45 according to the present embodiment not only provides information to the user but also serves as an “operation unit” operated by the user.

The target position setting unit 55 sets the target parking position SEP of the subject vehicle Vo based on the target parking space TS selected by the user. For example, when the user selects one parking spot as the target parking space TS, the target position setting unit 55 sets the selected parking spot as the target parking position SEP. When the user selects multiple parking spots as the target parking space TS, the target position setting unit 55 specifies one parking spot from the multiple selected parking spots, and sets the specified parking spot as the target parking position SEP. A method of specifying a parking spot is determined in consideration of, for example, convenience of the user. For example, the target position setting unit 55 preferentially sets a parking spot close to an entrance of a building BL such as a store among the multiple parking spots as the target parking position SEP.

When the parking spot included in the designated range indicated by the area information is an angled parking spot angled with respect to the traveling direction of the subject vehicle Vo, the orientation estimation unit 56 estimates whether a parking orientation is forward or backward based on a positional relationship between the angled parking spot and the subject vehicle Vo. The forward parking is a method of parking by moving the subject vehicle Vo from the front of the subject vehicle Vo to a vacant space. The backward parking is a method of parking by moving the subject vehicle Vo from the rear of the subject vehicle Vo to a vacant space.

The route generation unit 57 generates a target route through which the subject vehicle Vo should pass in the parking lot PL based on the results of the scene recognition, three-dimensional object recognition, and free space recognition. Specifically, the route generation unit 57 generates the search route DP for performing the search traveling in the parking lot PL during the search traveling as the target route. When the target parking position SEP is set by the target position setting unit 55, the route generation unit 57 generates the parking route TP leading to the target parking position SEP as the target route.

The position estimation unit 58 estimates the current position of the subject vehicle Vo based on the sensing information sequentially acquired by the surrounding monitoring sensor 3. For example, the position estimation unit 58 estimates the current position based on the sensing information acquired during the search traveling and the parking assistance.

The tracking control unit 59 automatically causes the subject vehicle Vo to move along a predetermined target route by performing vehicle motion control such as acceleration and deceleration control or steering control of the subject vehicle Vo. Specifically, the tracking control unit 59 causes the subject vehicle Vo to move along the target route based on the current position of the subject vehicle Vo estimated by the position estimation unit 58 and the target route. For example, when a predetermined condition is satisfied in the parking lot PL, the tracking control unit 59 automatically causes the subject vehicle Vo to move along the search route DP. In addition, the tracking control unit 59 automatically causes the vehicle V to move to the target parking position SEP along the parking route TP during the parking assistance. The above predetermined condition is satisfied, for example, when the subject vehicle Vo enters the parking lot PL or when the subject vehicle Vo cannot be parked at the target parking position SEP during the parking assistance. The tracking control unit 59 sets the traveling speed during the search traveling to a speed equal to or higher than the traveling speed during the parking assistance (for example, 1 km/h to 5 km/h). When there is a speed limit in the parking lot PL, the tracking control unit 59 sets the traveling speed with the speed limit as an upper limit.

The various ECUs 4 include a steering ECU 41 that performs steering control, a brake ECU 42 that performs the acceleration and deceleration control, a power management ECU 43, and a body ECU 44 that controls various electrical components such as lights and door mirrors.

Specifically, the tracking control unit 59 acquires the detection signals output from sensors such as the accelerator position sensor, the brake pedal force sensor, the steering angle sensor, the wheel speed sensor, and the shift position sensor mounted on the vehicle V via the vehicle information acquisition unit 52. Then, the tracking control unit 59 detects a state of each unit according to the acquired detection signals, and outputs a control signal to the various ECUs 4 in order to cause the subject vehicle Vo to move to track the search route DP and the parking route TP.

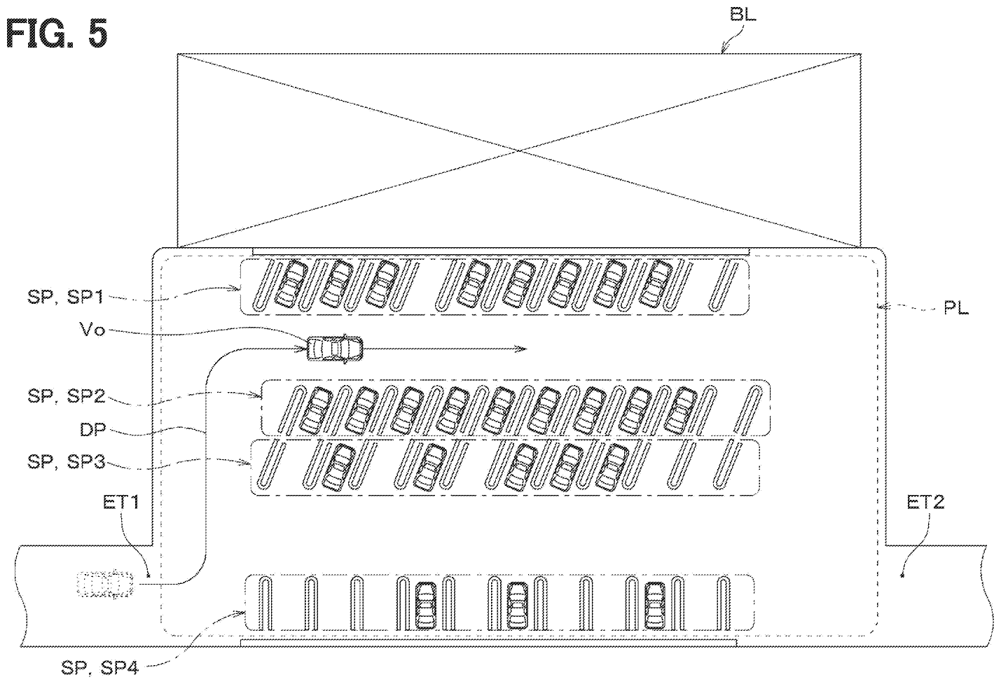

The automatic parking system 1 according to the present embodiment is implemented as described above. Next, operations of the automatic parking system 1 implemented as described above will be described. In the present embodiment, as shown in FIG. 5, a case where the subject vehicle Vo is to be parked in the parking lot PL provided with a large number of parking spots as the parking spaces SP will be described as an example. The parking lot PL shown in FIG. 5 is assumed to be a large-scale parking lot in front of the building BL provided in a shopping center, a service area of an expressway, or the like.

In the parking lot PL shown in FIG. 5, as the parking spaces SP, a first space SP1, a second space SP2, a third space SP3, and a fourth space SP4 in which multiple parking spots are horizontally disposed side by side are provided so as to be vertically disposed side by side. A passage through which the vehicle V travels is provided between the first space SP1 and the second space SP2. A passage through which the vehicle V travels is provided between the third space SP3 and the fourth space SP4. The second space SP2 and the third space SP3 are disposed close to each other, so that the vehicle V cannot pass therebetween. Gateways ET1 and ET2 of the parking lot PL are set on both sides of the fourth space SP4. Each of the first space SP1, the second space SP2, and the third space SP3 is provided with multiple angled parking spots that are angled with respect to the traveling direction of the vehicle V. The fourth space SP4 is provided with multiple perpendicular parking spots substantially orthogonal to the traveling direction of the vehicle V. FIG. 5 shows a state in which the subject vehicle Vo travels in the passage between the first space SP1 and the second space SP2 from one gateway ET1 side toward the other gateway ET2 side.

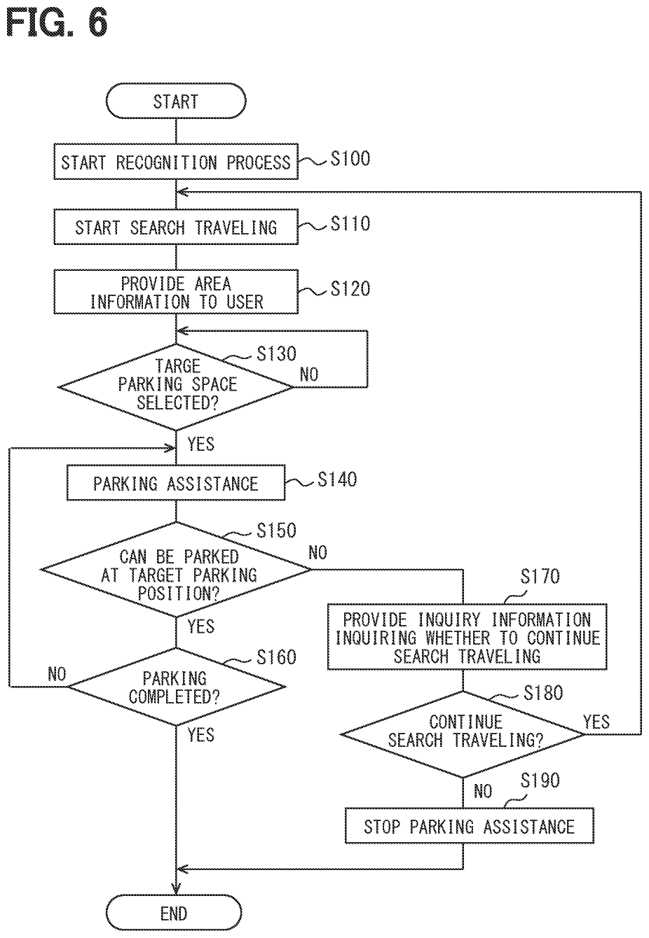

Hereinafter, a control process executed by the vehicle control unit 53 of the parking assistance device 5 will be described with reference to FIG. 6. The control process shown in FIG. 6 is executed by the vehicle control unit 53 when the instruction to perform the parking assistance is issued, for example, when the parking assistance switch (not shown) in the parking lot PL is operated by the user. Whether the subject vehicle Vo is positioned in the parking lot PL can be determined by using, for example, the map database 35 and the GPS 36. Each process shown in this flowchart is implemented by the functional units of the parking assistance device 5. Further, steps for implementing this processing are also understood as steps for implementing the parking assistance method.

As shown in FIG. 6, the vehicle control unit 53 starts a recognition process in step S100. In this recognition process, the recognition processing unit 51 starts the scene recognition, the three-dimensional object recognition, and the free space recognition based on the sensing information of the surrounding monitoring sensor 3.

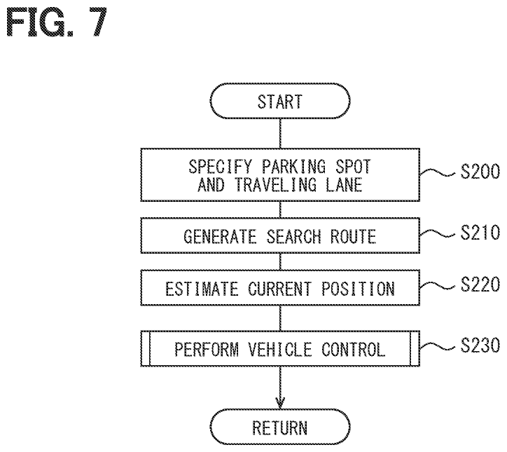

Subsequently, in step S110, the vehicle control unit 53 starts the search traveling in which the vehicle travels in the parking lot PL while searching the parking lot PL for the parking space SP. Hereinafter, an outline of a search traveling process of step S110 will be described with reference to a flowchart shown in FIG. 7.

As shown in FIG. 7, in step S200, the vehicle control unit 53 specifies the parking spot and the traveling lane based on the sensing information sequentially acquired by the surrounding monitoring sensor 3. In step S210, the vehicle control unit 53 generates the search route DP based on the sensing information sequentially acquired by the surrounding monitoring sensor 3. The process of step S210 is performed by the route generation unit 57 of the vehicle control unit 53.

Here, it is desirable that the vehicle control unit 53 displays, on the display unit 45a, an image in which an image indicating the search route DP is superimposed on the camera viewpoint image Gc and the overhead view image Gh or announces the search route DP to the user using the voice input and output unit 45b during the search traveling. In this manner, it is possible to inform the user of how the search traveling is implemented.

Subsequently, in step S220, the vehicle control unit 53 estimates the current position of the subject vehicle Vo based on the sensing information sequentially acquired by the surrounding monitoring sensor 3. The process of step S220 is performed by the position estimation unit 58 of the vehicle control unit 53.

Subsequently, in step S230, the vehicle control unit 53 performs the vehicle motion control such as the acceleration and deceleration control or the steering control of the subject vehicle Vo, thereby starting the search traveling for causing the subject vehicle Vo to automatically move along the search route DP. The process of step S230 is performed by the tracking control unit 59 of the vehicle control unit 53.

When the search traveling is started in step S110 of FIG. 6, in step S120, the vehicle control unit 53 provides, to the user, the area information having the range including multiple parking spots in the parking space SP as the designated range. The process of step S120 is performed by the information provision unit 54 of the vehicle control unit 53.

When the subject vehicle Vo travels while searching for a parking spot in a vacant state in the parking lot PL, the traveling speed of the subject vehicle Vo is likely to be greatly limited. The subject vehicle Vo being likely to be greatly limited is not preferable since a time required for parking becomes long and traffic congestion is likely to occur in the parking lot PL.

The vehicle control unit 53 according to the present embodiment first determines the designated range without considering the vacant state of the parking spot. Thereafter, the vehicle control unit 53 specifies the target parking space TS by utilizing recognition capability of the user for the vacant state of the parking spot.

For example, as shown in FIG. 3, the vehicle control unit 53 causes the display unit 45a to display, as the area information, an image obtained by superimposing the elliptical round frame images Ga on the camera viewpoint image Gc, and provides the message for prompting the selection of the target parking space TS to the user. The round frame image Ga shown in FIG. 3 indicates the designated range for the user to designate the target parking space TS. The size of the round frame image Ga is set to include multiple parking spots.

When the subject vehicle Vo travels in the passage between the first space SP1 and the second space SP2, the first space SP1 is shown on a left side and the second space SP2 is shown on a right side in the camera viewpoint image Gc. Both the first space SP1 and the second space SP2 may be the target parking space TS of the subject vehicle Vo. Therefore, the vehicle control unit 53 superimposes a first frame image Ga1 on a region corresponding to the first space SP1 in the camera viewpoint image Gc, and superimposes a second frame image Ga2 on a region corresponding to the second space SP2.

Here, for example, when the traveling speed of the subject vehicle Vo is high, the larger the designated range is, the more easily the user selects the target parking space TS. When the traveling speed of the subject vehicle Vo is high and a position of the designated range is close to the subject vehicle Vo, the subject vehicle Vo reaches the designated range in a short time, which makes it difficult to select the target parking space TS.

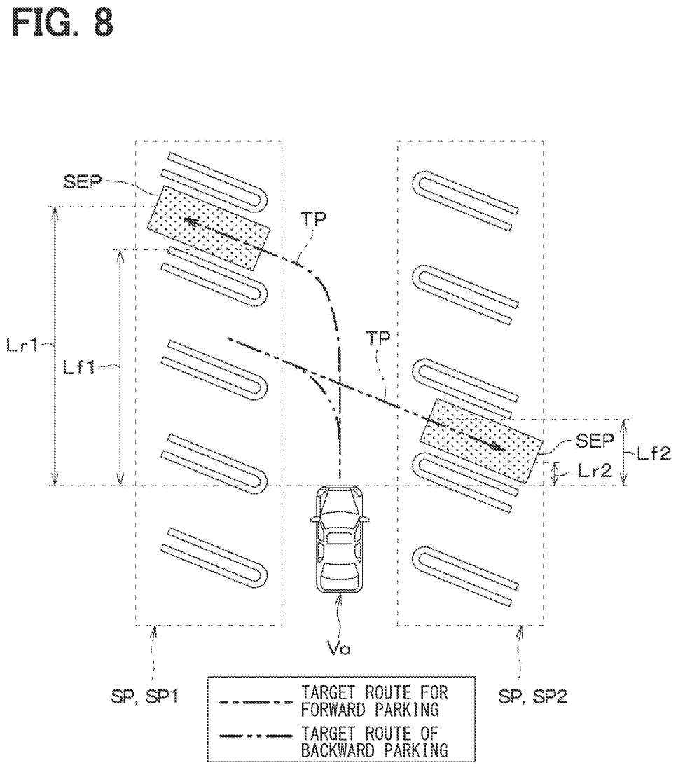

For example, as shown in FIG. 8, when the subject vehicle Vo is parked forward in a parking spot in the first space SP1, a parking operation is started before reaching a vicinity of the target parking position SEP. On the other hand, when the subject vehicle Vo is parked backward in a parking spot in the second space SP2, the parking operation is started after reaching the vicinity of the target parking position SEP. Therefore, it is necessary to determine the target parking position SEP earlier when the subject vehicle Vo is parked forward at the target parking position SEP as compared with the case where the subject vehicle Vo is parked backward.

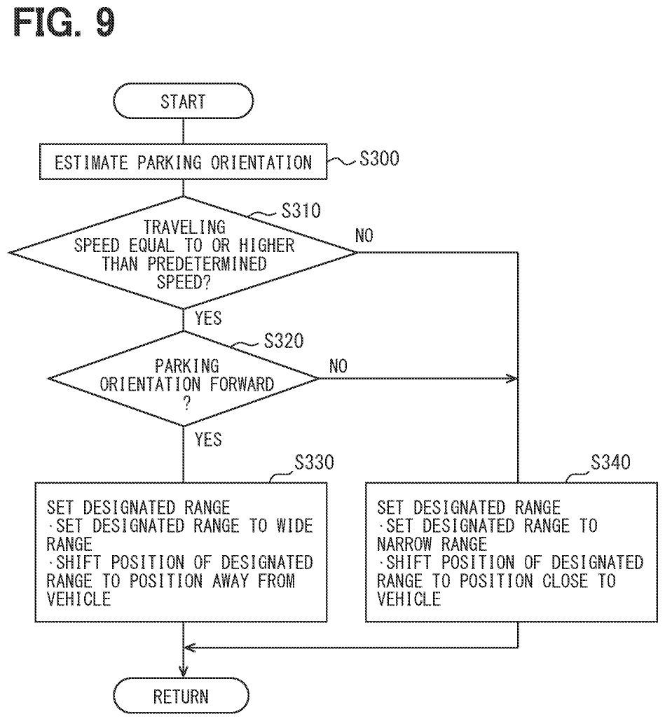

In consideration of the above, the vehicle control unit 53 executes a designation change process of changing the size of the designated range and the position of the designated range designated in the round frame image Ga according to the traveling speed and the parking orientation of the subject vehicle Vo during the search traveling. This process will be described with reference to the flowchart shown in FIG. 9. This process is performed by the information provision unit 54.

As shown in FIG. 9, the vehicle control unit 53 estimates the parking orientation of the subject vehicle Vo in step S300. When the parking orientation is designated in advance by the user, or when the parking orientation is designated by a sign or the like, the parking orientation is set according to the designation.

Here, as shown in FIG. 8, when angled parking spots are included in the parking spots of the parking space SP, it is estimated whether the parking orientation is forward or backward based on the positional relationship between the angled parking spot and the subject vehicle Vo. This estimation process is performed by the orientation estimation unit 56 of the vehicle control unit 53. This estimation process may be implemented when there are at least one angled parking spot in the parking spot of the parking space SP, or may be implemented when there are multiple angled parking spots in the parking spot of the parking space SP.

Specifically, the vehicle control unit 53 determines that the parking orientation is forward when a distance Lf from the subject vehicle Vo in the traveling direction of the subject vehicle Vo to a near side of the angled parking spot is smaller than a distance Lr to a far side. In addition, the vehicle control unit 53 determines that the parking orientation is backward when the distance Lr from the subject vehicle Vo in the traveling direction of the subject vehicle Vo to the far side of the angled parking spot is smaller than the distance Lf to the near side. The distance Lf from the subject vehicle Vo to the near side of the angled parking spot is, for example, a length from the subject vehicle Vo to a reference position (for example, a center portion) on the near side of the angled parking spot. The distance Lr from the subject vehicle Vo to the far side of the angled parking spot is, for example, a length from the subject vehicle Vo to a reference position (for example, a center portion) on the far side of the angled parking spot. The distances Lf and Lr may be defined as lengths different from those described above.

For example, as shown in FIG. 8, the parking orientation of the parking spot in the first space SP1 is determined to be forward since a distance Lf1 to the near side of the angled parking spot is smaller than a distance Lr1 to the far side. In addition, the parking orientation of the parking spot in the second space SP2 is determined to be backward since the distance Lr1 to the far side of the angled parking spot is smaller than a distance Lf2 to the near side. As shown in FIG. 8, when there is a white line as a parking marking, the vehicle control unit 53 may estimate the parking orientation based on an inclination state of the white line. For example, the vehicle control unit 53 may estimate a parking orientation of the vehicle V parked around the subject vehicle Vo as the parking orientation of the subject vehicle Vo.

Subsequently, in step S310, the vehicle control unit 53 determines whether the traveling speed of the subject vehicle Vo is equal to or higher than a predetermined speed. The predetermined speed is set to, for example, a traveling speed (for example, 5 km/h to 10 km/h) assumed during the parking assistance.

When the traveling speed of the subject vehicle Vo is equal to or higher than the predetermined speed, the vehicle control unit 53 determines whether the parking orientation is forward in step S320. This determination process is performed based on the estimation result of the parking orientation in step S300.

When the parking orientation is forward, in step S330, the vehicle control unit 53 sets the size of the frame such that the designated range designated by the round frame image Ga becomes a wide range, and sets the position of the frame to an upper side such that the position of the designated range is shifted to a position away from the subject vehicle Vo.

As described above, the parking orientation of the first space SP1 is forward. Therefore, when the traveling speed of the subject vehicle Vo is equal to or higher than the predetermined speed, on a region corresponding to the first space SP1, the first frame image Ga1 having a wide range above the region is superimposed. In the first frame image Ga1 shown in FIG. 8, a range including four parking spots is set as the designated range. The first frame image Ga1 shown in FIG. 8 is an example, and may have a different size or position.

On the other hand, when the traveling speed of the subject vehicle Vo is less than the predetermined speed or the parking orientation of the subject vehicle Vo is backward, the vehicle control unit 53 proceeds to step S340. In step S340, the vehicle control unit 53 sets the size of the frame such that the designated range designated by the round frame image Ga becomes a narrow range, and sets the position of the frame to a lower side such that the position of the designated range is shifted to a position close to the subject vehicle Vo.

As described above, the parking orientation of the second space SP2 is backward. Therefore, on a region corresponding to the second space SP2, the second frame image Ga2 having a narrow range below the region is superimposed. Incidentally, in the second frame image Ga2 shown in FIG. 8, a range including two parking spots is set as the designated range. The second frame image Ga2 shown in FIG. 8 is an example, and may have a different size or position.

Although not shown, when the traveling speed of the subject vehicle Vo is less than the predetermined speed, on the region corresponding to the first space SP1, the first frame image Ga1 having a narrow range below the region is superimposed. In the first frame image Ga1, a range including a smaller number of parking spots than when the traveling speed of the subject vehicle Vo is equal to or higher than the predetermined speed is set as the designated range.

After providing the area information to the user in this manner, the vehicle control unit 53 determines whether the target parking space TS is selected by the user in step S130. This determination process is performed based on, for example, an operation signal of a touch operation on the display unit 45a and a recognition result of information uttered by the user.

The vehicle control unit 53 is on standby until the target parking space TS is selected, and proceeds to step S140 when the target parking space TS is selected. When the vehicle control unit 53 acquires the selection result of the target parking space TS by the user based on the operation signal of the touch operation on the display unit 45a and the recognition result of information uttered by the user, the process proceeds to step S140.

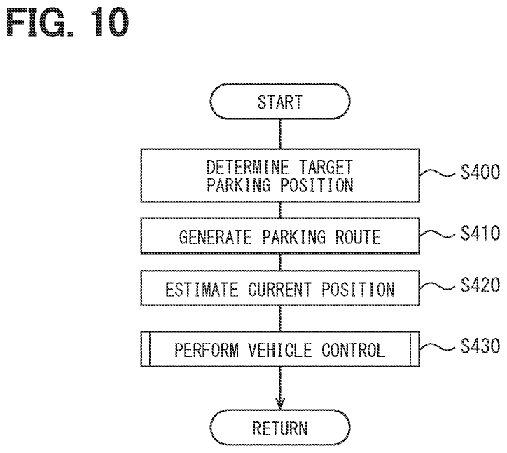

In step S140, the vehicle control unit 53 starts the parking assistance of the subject vehicle Vo. The process of step S140 may be started when there is an instruction from the user. Hereinafter, an outline of a parking assistance process of step S140 will be described with reference to a flowchart shown in FIG. 10.

As shown in FIG. 10, in step S400, the vehicle control unit 53 determines the target parking position SEP of the subject vehicle Vo based on the target parking space TS selected by the user. The process of step S400 is performed by the target position setting unit 55 of the vehicle control unit 53.

Subsequently, in step S410, the vehicle control unit 53 generates the parking route TP to the target parking position SEP. The process of step S410 is performed by the route generation unit 57 of the vehicle control unit 53.

Here, it is desirable that the vehicle control unit 53 displays, on the display unit 45a, an image in which an image indicating the parking route TP is superimposed on the camera viewpoint image Gc and the overhead view image Gh or announces the parking route TP to the user using the voice input and output unit 45b during the parking assistance. In this manner, it is possible to inform the user of how the parking assistance is implemented.

Subsequently, in step S420, the vehicle control unit 53 estimates the current position of the subject vehicle Vo based on the sensing information sequentially acquired by the surrounding monitoring sensor 3. The process of step S420 is performed by the position estimation unit 58 of the vehicle control unit 53.

Subsequently, in step S430, the vehicle control unit 53 performs the vehicle motion control such as the acceleration and deceleration control or the steering control of the subject vehicle Vo, so as to cause the subject vehicle Vo to move along the parking route TP and park the subject vehicle Vo at the target parking position SEP. The process of step S430 is performed by the tracking control unit 59 of the vehicle control unit 53.

When the parking assistance is started in step S140 of FIG. 6, the vehicle control unit 53 determines whether the subject vehicle Vo can be parked at the target parking position SEP in step S150. This determination process is performed based on, for example, the detection results of obstacles near the parking route TP and the target parking position SEP of the vehicle V sequentially acquired by the recognition processing unit 51.

When the subject vehicle Vo can be parked at the target parking position SEP, the vehicle control unit 53 determines whether the parking at the target parking position SEP is completed in step S160. For example, when a shift position of the subject vehicle Vo is switched to a position (for example, P position) indicating parking at the target parking position SEP, the vehicle control unit 53 determines that the parking at the target parking position SEP is completed.

When the parking at the target parking position SEP is completed, the vehicle control unit 53 exits from this control process, and when the parking at the target parking position SEP is not completed, the vehicle control unit 53 returns to step S140 and continues the parking assistance.

On the other hand, when the subject vehicle Vo cannot be parked at the target parking position SEP, the parking assistance at the target parking position SEP cannot be continued, and the subject vehicle Vo needs to be parked at another place. Therefore, when the subject vehicle Vo cannot be parked at the target parking position SEP, the vehicle control unit 53 provides the user with inquiry information for inquiring whether to continue the search traveling in step S170. This inquiry process is performed by the information provision unit 54 of the vehicle control unit 53. The vehicle control unit 53 implements the provision of the inquiry information to the user by, for example, displaying a message inquiring whether to continue the search traveling on the display unit 45a and outputting a voice inquiring whether to continue the search traveling from the voice input and output unit 45b.

Subsequently, in step S180, the vehicle control unit 53 determines whether to continue the search traveling. For example, the vehicle control unit 53 determines whether to continue the search traveling by recognizing an intention of the user regarding whether to continue the search traveling based on an operation signal of a touch operation on the display unit 45a or a recognition result of information uttered by the user.

When the search traveling is continued, the vehicle control unit 53 returns to step S110. That is, when the intention of the user is to continue the search traveling, the vehicle control unit 53 switches from the parking assistance to the search traveling.

On the other hand, when the search traveling is not continued, the vehicle control unit 53 stops the parking assistance in step S190. For example, the vehicle control unit 53 switches the vehicle motion control such as the acceleration and deceleration control and the steering control of the subject vehicle Vo from automatic control to manual control.

The parking assistance device 5 and the parking assistance method described above search the parking lot PL for the parking space SP for parking the subject vehicle Vo based on the surrounding information of the subject vehicle Vo acquired by the surrounding monitoring sensor 3 mounted on the subject vehicle Vo. The parking assistance device 5 and the parking assistance method provide the user with the information for prompting the selection of the target parking space TS in which the subject vehicle Vo is parked from the parking spaces SP obtained as the search result in the parking lot PL. The parking assistance device 5 and the parking assistance method set the target parking position SEP of the subject vehicle Vo based on the target parking space TS selected by the user. The parking assistance device 5 and the parking assistance method provide the user with the area information having a range including multiple parking spots in the parking space SP as the designated range when prompting the user to select the target parking space TS in which the subject vehicle Vo is to be parked from the parking space SP.

As described above, it is desirable to provide the user with the area information having the range including the multiple parking spots in the parking space SP as the designated range, and set the target parking position SEP from the target parking space TS selected by the user based on the provided information. In this manner, even in a situation where it is difficult to specify a single parking spot suitable for parking the subject vehicle Vo by the free space recognition unit 51c, the target parking position SEP can be set by effective utilizing the recognition capability of the user.

According to the present embodiment, the following effects can be obtained.
(1) When the search traveling is performed in which the vehicle travels in the parking lot PL while searching for the parking space SP in the parking lot PL, the information provision unit 54 provides the area information to the user.

A situation in which it is difficult to specify a parking spot suitable for parking the subject vehicle Vo by the free space recognition unit 51c tends to occur during the search traveling in the parking lot PL in which there are many obstacles such as other vehicles. Therefore, it is desirable to provide the user with the area information having the multiple parking spots in the parking space SP as the designated range during the search traveling and set the target parking position SEP from the target parking space TS selected by the user based on the provided information.
(2) The information provision unit 54 changes at least one of the size of the designated range and the position of the designated range according to the traveling speed of the subject vehicle Vo during the search traveling. For example, when the traveling speed of the subject vehicle Vo is high, the larger the designated range is, the more easily the user selects the target parking space TS. When the traveling speed of the subject vehicle Vo is high and a position of the designated range is close to the subject vehicle Vo, the subject vehicle Vo reaches the designated range in a short time, which makes it difficult to select the target parking space TS. In consideration of the above, it is desirable that at least one of the size of the designated range and the position of the designated range is changed according to the traveling speed of the subject vehicle Vo during the search traveling. Accordingly, it is possible to restrict rapid deceleration in the vicinity of the target parking position SEP and excessive turning, and to improve convenience.
(3) The information provision unit 54 changes the size of the designated range such that the size of the designated range increases as the traveling speed of the subject vehicle Vo during the search traveling increases. Accordingly, even when the traveling speed of the subject vehicle Vo is high, the user can easily select the target parking space TS.
(4) The information provision unit 54 changes the position of the designated range such that the position of the designated range is shifted to a position away from the subject vehicle Vo as the traveling speed of the subject vehicle Vo during the search traveling increases. Accordingly, even when the traveling speed of the subject vehicle Vo is high, the user can easily select the target parking space TS from the designated range.
(5) The information provision unit 54 changes at least one of the size of the designated range and the position of the designated range according to the parking orientation of the subject vehicle Vo at the target parking position SEP.

When the subject vehicle Vo is parked backward, the parking operation is started after reaching the vicinity of the target parking position SEP. On the other hand, when the subject vehicle Vo is parked forward, the parking operation is started before reaching the vicinity of the target parking position SEP. Therefore, it is necessary to determine the target parking position SEP earlier when the subject vehicle Vo is parked forward at the target parking position SEP as compared with the case where the subject vehicle Vo is parked backward. In consideration of the above, it is desirable that at least one of the size of the designated range and the position of the designated range is changed according to the parking orientation of the subject vehicle Vo at the target parking position SEP. Accordingly, it is possible to restrict rapid deceleration in the vicinity of the target parking position SEP and excessive turning, and to improve convenience.
(6) The information provision unit 54 changes the size of the designated range such that the size of the designated range is enlarged when the subject vehicle Vo is parked forward at the target parking position SEP as compared with the case where the subject vehicle Vo is parked backward. Accordingly, even when the subject vehicle Vo is parked forward at the target parking position SEP, the user can easily select the target parking space TS from the designated range.
(7) The information provision unit 54 changes the position of the designated range such that the position of the designated range is shifted to a position away from the subject vehicle Vo when the subject vehicle Vo is parked forward at the target parking position SEP as compared with the case where the subject vehicle Vo is parked backward. Accordingly, even when the subject vehicle Vo is parked forward at the target parking position SEP, the user can easily select the target parking space TS from the designated range.
(8) The parking assistance device 5 includes an orientation estimation unit 56 that estimates whether a parking orientation is forward or backward based on a positional relationship between the angled parking spot and the subject vehicle Vo when the parking spot included in the designated range is an angled parking spot angled with respect to the traveling direction of the subject vehicle Vo. In this manner, it is desirable to automatically determine the parking orientation with respect to the angled parking spot.
(9) The orientation estimation unit 56 determines that the parking orientation is forward when a distance Lf from the subject vehicle Vo in the traveling direction of the subject vehicle Vo to a near side of the angled parking spot is smaller than a distance Lr to a far side. In addition, the orientation estimation unit 56 determines that the parking orientation is backward when the distance Lr from the subject vehicle Vo in the traveling direction of the subject vehicle Vo to the far side of the angled parking spot is smaller than the distance Lf to the near side. Accordingly, the parking orientation with respect to the angled parking spot can be automatically determined.
(10) The parking assistance device 5 includes a tracking control unit 59 that causes the subject vehicle Vo to automatically move along a predetermined target route. When a predetermined condition is satisfied in the parking lot PL, the tracking control unit 59 causes the subject vehicle Vo to automatically move along the search route DP generated for performing the search traveling in the parking lot PL as the target route. In this manner, when the subject vehicle Vo automatically moves along the search route DP during the search traveling, a burden on the user during the search traveling is reduced, and thus the convenience can be further improved.
(11) The predetermined condition is satisfied when the subject vehicle Vo cannot be parked at least at the target parking position SEP. As described above, when the subject vehicle Vo cannot be parked at the target parking position SEP, it is desirable to shift to the search traveling in which the subject vehicle Vo automatically moves along the search route DP. Accordingly, it is possible to further improve the convenience by reducing the burden on the user during the search traveling. In the present embodiment, when an instruction to perform the parking assistance is issued from a user side in the parking lot PL, the search traveling is started. Therefore, the above-described predetermined condition is also satisfied when the instruction to perform the parking assistance is issued from the user side in the parking lot PL.
(12) The parking assistance device 5 includes the route generation unit 57 that generates the target route through which the subject vehicle Vo should pass in the parking lot PL. When the target parking position SEP is set by the target position setting unit 55, the route generation unit 57 generates the parking route TP leading to the target parking position SEP as the target route. When the parking route TP is generated by the route generation unit 57, the tracking control unit 59 causes the subject vehicle Vo to automatically move to the target parking position SEP along the parking route TP. In this manner, when the subject vehicle Vo automatically moves along the target route during the parking assistance, the burden on the user during the parking assistance is reduced, and thus it is possible to further improve the convenience.
(13) The information provision unit 54 provides the area information to the user in the visual manner. Accordingly, the user can select the target parking space TS in which the subject vehicle Vo is to be parked from the parking space SP after clearly grasping the designated range included in the parking space SP. Accordingly, it is possible to improve the convenience of the parking assistance.

### Modification of Area Information

The embodiment described above show the example in which the image in which the round frame image Ga indicating the designated range is superimposed on the camera viewpoint image Gc is displayed on the display unit 45a as the area information, but a display form of the designated range indicated as the area information is not limited thereto. The display form of the designated range indicated as the area information can be modified as follows, for example.

### First Modification

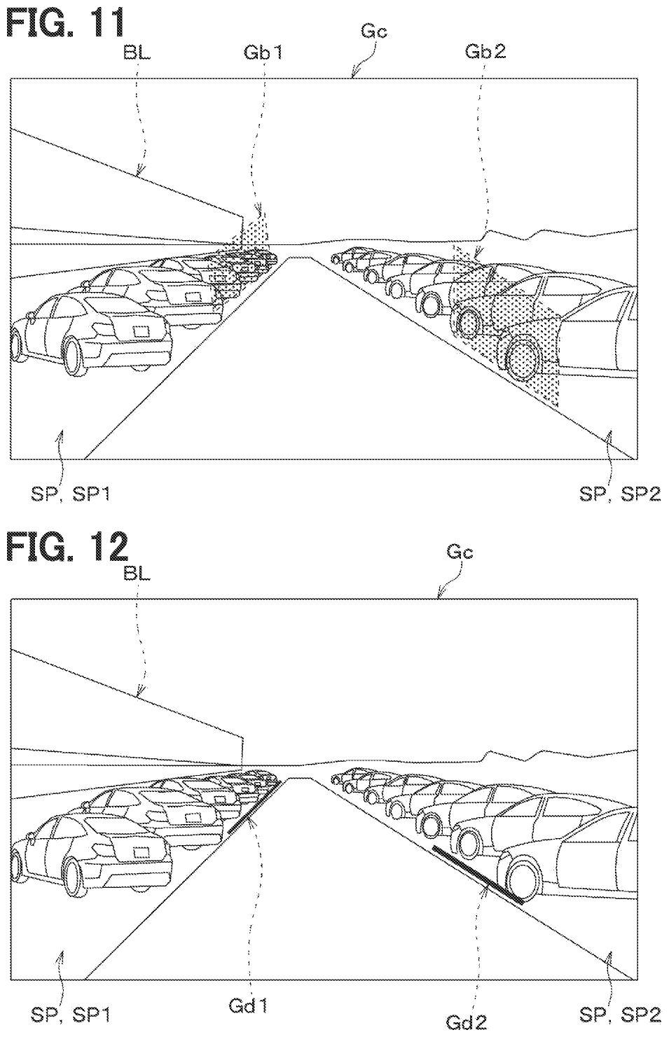

For example, as shown in FIG. 11, the vehicle control unit 53 may cause the display unit 45a to display an image obtained by superimposing angular frame images Gb1 and Gb2 each having a quadrilateral shape indicating the designated range on the camera viewpoint image Gc as the area information. The shape of each of the angular frame images Gb1 and Gb2 is not limited to the quadrilateral shape, and may be another polygonal shape such as a triangular shape or a pentagon shape.

### Second Modification

As shown in FIG. 12, the vehicle control unit 53 may cause the display unit 45a to display an image obtained by superimposing range designation lines Gd1 and Gd2, which are thick lines indicating the designated range, on the camera viewpoint image Gc as the area information.

### Third Modification

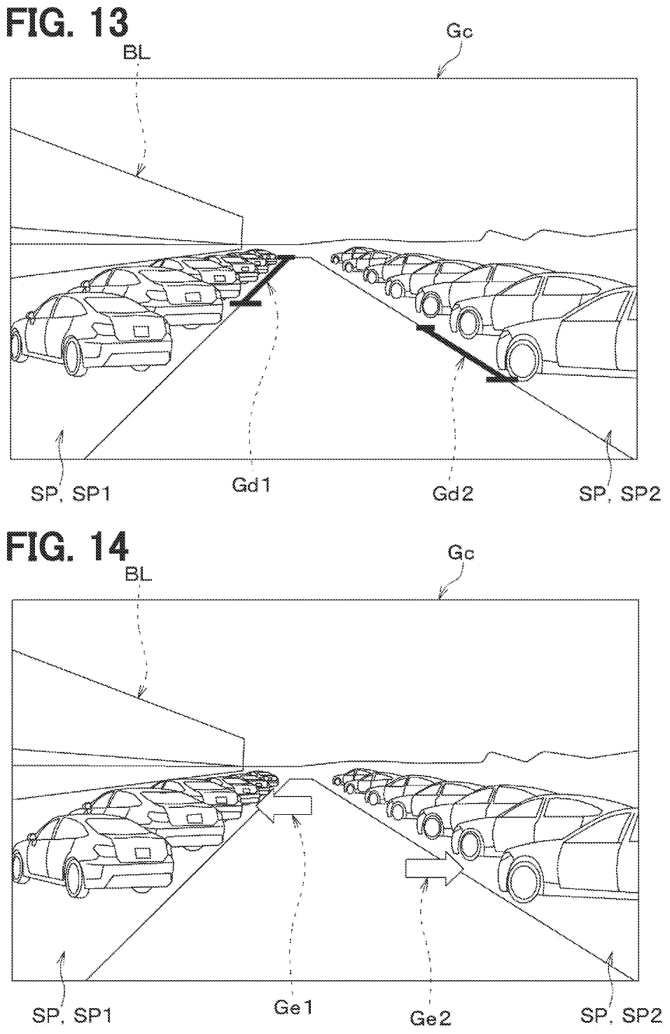

In the range designation lines Gd1 and Gd2 described above, as shown in FIG. 13, both end positions of the designated range may be emphasized. It is desirable that the range designation lines Gd1 and Gd2 be emphasized by coloring with red or the like or by blinking. The same applies to the above-described round frame image Ga, the angular frame image Gb, or those described later.

### Fourth Modification

For example, as shown in FIG. 14, the vehicle control unit 53 may cause the display unit 45a to display an image obtained by superimposing arrow images Ge1 and Ge2 each having an arrowhead shape indicating the designated range on the camera viewpoint image Gc as the area information. Although the arrow images Ge1 and Ge2 are reflected in the camera viewpoint image Gc, the arrow images Ge1 and Ge2 are preferably shown in a semi-transparent manner in order to ensure visibility. It is desirable that sizes of the arrow images Ge1 and Ge2 change according to a distance from the subject vehicle Vo.

### Fifth Modification

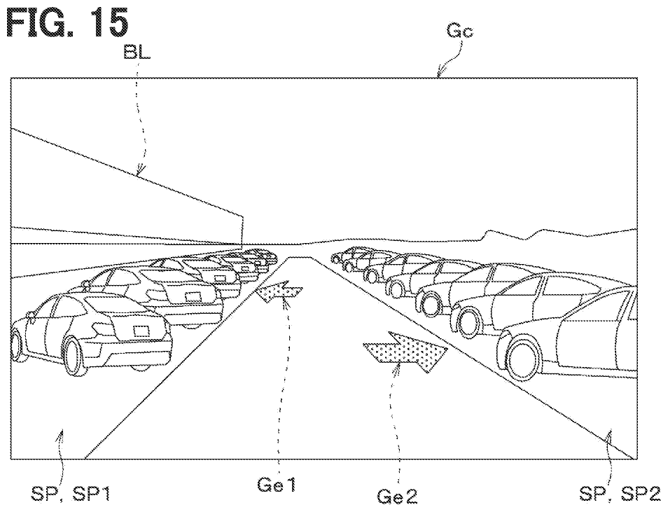

As shown in FIG. 15, the arrow images Ge1 and Ge2 are preferably superimposed on the camera viewpoint image Gc at positions where interference with another vehicle is avoided (for example, positions where a passage for the subject vehicle Vo traveling is present).

### Sixth Modification

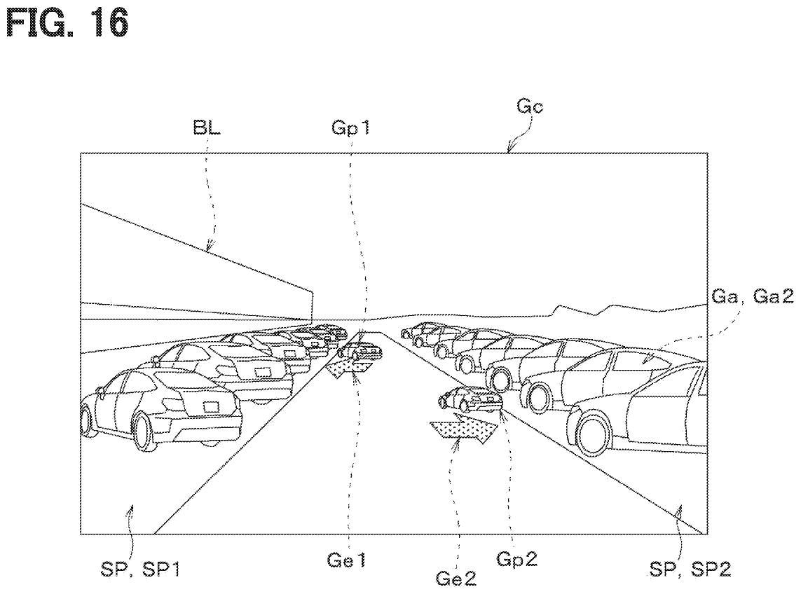

As shown in FIG. 16, the vehicle control unit 53 preferably cause the display unit 45a to display an image obtained by superimposing polygons Gp1 and Gp2 of the vehicle V indicating the parking orientation on the camera viewpoint image Gc in addition to the arrow images Ge1 and Ge2 as the area information.

### Seventh Modification

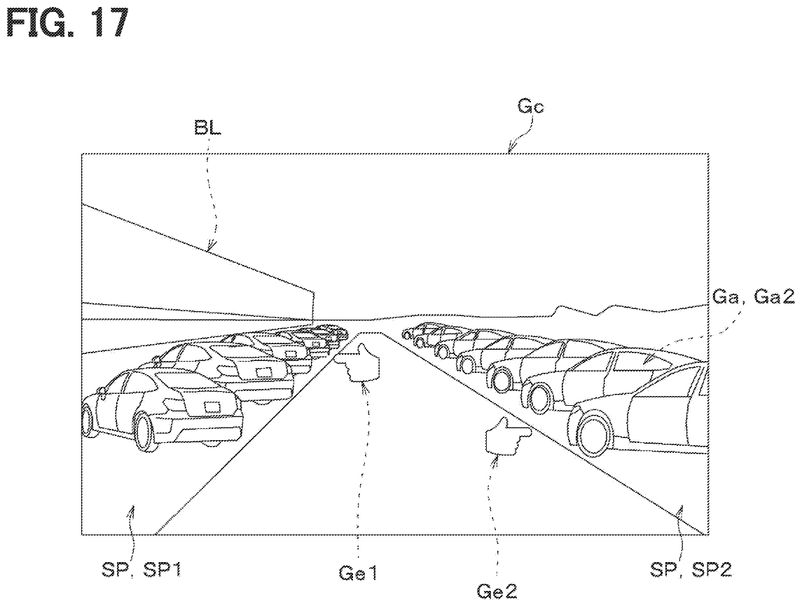

The arrow images Ge1 and Ge2 described above are not limited to have the arrowhead shape. As the arrow images Ge1 and Ge2, for example, as shown in FIG. 17, an illustration image indicating a direction with a finger of a hand may be adopted.

### Another Example of Parking Lot

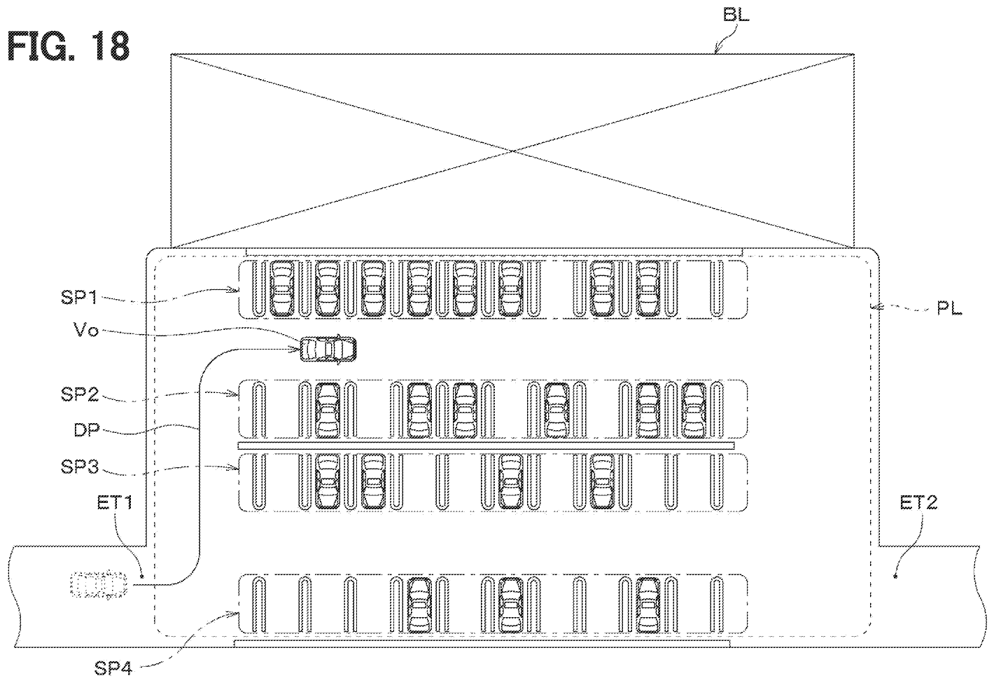

In the above-described embodiment, the parking lot PL including the angled parking spots is described as an example, but the parking lot PL is not limited thereto. For example, as shown in FIG. 18, the parking lot PL may not include the angled parking spots. Although not shown, the parking lot PL may include parallel parking spots. Although not shown, the parking lot PL is not limited to have the parking spaces SP provided on both sides of the subject vehicle Vo in a width direction, and the parking spaces SP may be provided only on one side of the subject vehicle Vo in the width direction.

### Other Embodiments

Although representative embodiments according to the present disclosure are described above, the present disclosure is not limited to the above-described embodiments, and various modifications can be made, for example, as follows.

In the above-described embodiment, the detailed configuration of the parking assistance device 5, and the details of the search traveling and parking assistance are described, but the parking assistance device 5 and the parking assistance method are not limited to those described above, and a part thereof may be different. For example, the parking assistance device 5 includes the map database 35 and the GPS 36, but the map database 35 and the GPS 36 are not essential, and may be omitted.

The information provision unit 54 according to the above-described embodiment provides the area information to the user when the search traveling is performed in the parking lot PL, but the present disclosure is not limited thereto, and for example, the area information may be provided in response to a request from the user.

The information provision unit 54 according to the above-described embodiment changes each of the size of the designated range and the position of the designated range according to whether the traveling speed of the subject vehicle Vo during the search traveling is equal to or higher than the predetermined speed, but the present disclosure is not limited thereto. For example, the information provision unit 54 may change at least one of the size of the designated range and the position of the designated range gradually or stepwise according to the traveling speed of the subject vehicle Vo during the search traveling. The information provision unit 54 may change only one of the size of the designated range and the position of the designated range according to the traveling speed of the subject vehicle Vo during the search traveling. The information provision unit 54 may set the designated range to a predetermined size and position regardless of the traveling speed of the subject vehicle Vo during the search traveling.

The information provision unit 54 according to the above-described embodiment changes each of the size of the designated range and the position of the designated range according to the parking orientation of the subject vehicle Vo at the target parking position SEP, but the present disclosure is not limited thereto. For example, the information provision unit 54 may change only one of the size of the designated range and the position of the designated range according to the parking orientation of the subject vehicle Vo. The information provision unit 54 may set the designated range to a predetermined size and position of the designated range regardless of the parking orientation of the subject vehicle Vo. In the above-described embodiment, the two patterns shown in FIG. 9 are exemplified as the designated range, but the designated range is not limited thereto. For example, the information provision unit 54 may change the position or the like of the designated range in several steps according to the traveling speed of the subject vehicle Vo, or may linearly change the position or the like of the designated range according to the traveling speed of the subject vehicle Vo.

The information provision unit 54 according to the above-described embodiment may change the size of the designated range and the position of the designated range according to an element other than the traveling speed and the parking orientation of the subject vehicle Vo. For example, the information provision unit 54 may change the size of the designated range and the position of the designated range according to the traveling position of the subject vehicle Vo in the width direction of the passage in the parking lot PL.

As in the embodiment described above, when the parking spot in the designated range is the angled parking spot, the parking assistance device 5 preferably estimates whether the parking orientation is forward or backward, but the present disclosure is not limited thereto. The parking assistance device 5 may not estimate the parking orientation.

The parking assistance device 5 according to the above-described embodiment causes the subject vehicle Vo to automatically move so as to track the target route during each of the search traveling and the parking assistance, but the generation of the target route and that the tracking of the target route are not essential. That is, the parking assistance device 5 may not cause the subject vehicle Vo to automatically move along the search route DP during the search traveling. In addition, the parking assistance device 5 may not cause the subject vehicle Vo to automatically move along the parking route TP during the parking assistance.

As in the above-described embodiment, it is desirable that the information provision unit 54 provides the area information to the user in the visual manner, but the present disclosure is not limited thereto. The information provision unit 54 may provide the area information to the user in the auditory manner (for example, notification by voice).

In the above-described embodiment, the example in which the parking assistance device 5 sets the target parking position SEP based on the target parking space TS selected by the user is described, but the present disclosure is not limited thereto. For example, the parking assistance device 5 may set the target parking position SEP based on the target parking space TS selected by the user only when a management system of the parking lot PL does not have information on the vacant state of the parking spot. When the management system of the parking lot PL has the information on the vacant state of the parking spot, the parking assistance device 5 may acquire the information from the management system and set the target parking position SEP using the information.

In the above-described embodiment, the example in which the parking assistance device 5 according to the present disclosure is applied to the parking assistance in the large-scale parking lot PL is described, but the present disclosure is not limited thereto, and the parking assistance device 5 can also be applied to parking assistance in the medium-scale or small-scale parking lot PL in which multiple parking spots are provided.

In the embodiments described above, it is needless to say that the elements configuring the embodiments are not necessarily essential except in the case where those elements are clearly indicated to be essential in particular, the case where those elements are considered to be obviously essential in principle, and the like.

In the embodiments described above, the present disclosure is not limited to the specific number of components of the embodiments, except when numerical values such as the number, numerical values, quantities, ranges, and the like are referred to, particularly when it is expressly indispensable, and when it is obviously limited to the specific number in principle, and the like.

In the embodiments described above, when referring to the shape, positional relationship, and the like of a component and the like, it is not limited to the shape, positional relationship, and the like, except for the case where it is specifically specified, the case where it is fundamentally limited to a specific shape, positional relationship, and the like, and the like.

In the above-described embodiment, when it is described that external environment information of the vehicle V is acquired from a sensor, the sensor may be abolished and the external environment information may be received from a server or a cloud outside the vehicle. Alternatively, it is also possible to eliminate the sensor, acquire related information related to the external environmental information from a server or a cloud outside the vehicle, and estimate the external environmental information based on the acquired related information.

The controller and the method described in the present disclosure may be implemented by a special purpose computer, which includes a memory and a processor programmed to execute one or more special functions implemented by computer programs of the memory. The controller and the method described in the present disclosure may be implemented by a special purpose computer including a processor with one or more dedicated hardware logic circuits. The controller and the method described in the present disclosure may be implemented by a combination of (i) a special purpose computer including a processor programmed to execute one or more functions by executing a computer program and a memory and (ii) a special purpose computer including a processor with one or more dedicated hardware logic circuits. The computer program may be stored in a computer-readable non-transitory tangible recording medium as an instruction to be executed by a computer.

What is claimed is:

1. A parking assistance device that assists traveling and parking of a vehicle in a parking lot, the parking assistance device comprising:
a space recognition unit configured to search for a parking space for parking the vehicle in the parking lot based on surrounding information of the vehicle acquired by a surrounding monitoring sensor mounted on the vehicle;
an information provision unit configured to provide a user with information for prompting a selection of a target parking space for parking the vehicle from the parking space obtained as a search result in the parking lot; and
a target position setting unit configured to set a target parking position of the vehicle based on the target parking space selected by the user,
wherein
the information provision unit provides the user with area information having a range including a plurality of parking spots in the parking space as a designated range.

2. The parking assistance device according to claim 1, wherein
when search traveling is performed in which the vehicle travels in the parking lot while searching for the parking space in the parking lot, the information provision unit provides the area information to the user.

3. The parking assistance device according to claim 2, wherein
the information provision unit changes at least one of a size of the designated range and a position of the designated range according to a traveling speed of the vehicle during the search traveling.

4. The parking assistance device according to claim 3, wherein
the information provision unit changes the size of the designated range such that the size of the designated range increases as the traveling speed of the vehicle during the search traveling increases.

5. The parking assistance device according to claim 3, wherein
the information provision unit changes the position of the designated range such that the position of the designated range is shifted to a position away from the vehicle as the traveling speed of the vehicle during the search traveling increases.

6. The parking assistance device according to claim 2, wherein
the information provision unit changes at least one of the size of the designated range and the position of the designated range according to a parking orientation of the vehicle at the target parking position.

7. The parking assistance device according to claim 6, wherein
the information provision unit changes the size of the designated range such that the size of the designated range increases when the vehicle is parked forward at the target parking position as compared with a case where the vehicle is parked backward.

8. The parking assistance device according to claim 6, wherein
the information provision unit changes the position of the designated range such that the position of the designated range is shifted to a position away from the vehicle when the vehicle is parked forward at the target parking position as compared with a case where the vehicle is parked backward.

9. The parking assistance device according to claim 6, further comprising:
an orientation estimation unit configured to estimate whether the parking orientation is forward or backward based on a positional relationship between an angled parking spot and the vehicle when the parking spot included in the designated range is the angled parking spot angled with respect to a traveling direction of the vehicle.

10. The parking assistance device according to claim 9, wherein
the orientation estimation unit
determines that the parking orientation is forward when a distance from the vehicle in the traveling direction to a near side in the angled parking spot is smaller than a distance to a far side, and
determines that the parking orientation is backward when the distance from the vehicle in the traveling direction to the far side in the angled parking spot is smaller than the distance to the near side.

11. The parking assistance device according to claim 2, further comprising:
a tracking control unit configured to cause the vehicle to automatically move along a predetermined target route,
wherein
when a predetermined condition is satisfied in the parking lot, the tracking control unit causes the vehicle to automatically move along a search route generated to perform the search traveling in the parking lot as a target route.

12. The parking assistance device according to claim 11, wherein
the predetermined condition is satisfied when the vehicle cannot be parked at least at the target parking position.

13. The parking assistance device according to claim 11, further comprising:
a route generation unit configured to generate the target route,
wherein
when the target parking position is set by the target position setting unit, the route generation unit generates a parking route leading to the target parking position as the target route, and
when the parking route is generated by the route generation unit, the tracking control unit causes the vehicle to automatically move to the target parking position along the parking route.

14. The parking assistance device according to claim 1, wherein
the information provision unit provides the area information to the user in a visual manner.

15. A parking assistance method that assists traveling and parking of a vehicle in a parking lot, the parking assistance method comprising:
searching for a parking space for parking the vehicle in the parking lot based on surrounding information of the vehicle acquired by a surrounding monitoring sensor mounted on the vehicle;
providing a user with information for prompting a selection of a target parking space for parking the vehicle from the parking space obtained as a search result in the parking lot; and
setting a target parking position of the vehicle based on the target parking space selected by the user, wherein
when a selection of the target parking space in which the vehicle is to be parked from the parking space is promoted, the user is provided with area information having a range including a plurality of parking spots in the parking space as a designated range.
